(19) United States
(12) Patent Application Publication
(10) Pub. No.: US 2014/0076064 A1
(43) Pub. Date: Mar. 20, 2014

(54) RELATIVE ROTATIONAL ANGULAR DISPLACEMENT DETECTION DEVICE, TORQUE DETECTION DEVICE, TORQUE CONTROL DEVICE, AND VEHICLE

(71) Applicant: YAMAHA HATSUDOKI KABUSHIKI KAISHA, Shizuoka-shi (JP)

(72) Inventors: Haruyoshi HINO, Shizuoka-ken (JP); Kazuto NAKAMURA, Shizuoka-ken (JP)

(73) Assignee: YAMAHA HATSUDOKI KABUSHIKI KAISHA, Shizuoka-ken (JP)

(21) Appl. No.: 14/024,167

(22) Filed: Sep. 11, 2013

(30) Foreign Application Priority Data
Sep. 14, 2012 (JP) 2012-202935

(51) Int. Cl. G01B 7/30; G01L 3/10

(52) U.S. Cl. CPC G01B 7/30; G01L 3/104
USPC 73/862.325; 324/207.25

(57) ABSTRACT

A relative rotational angular displacement detection device includes a pair of rotatable members relatively rotatable in a circumferential direction. A permanent magnet is attached to one of the rotatable members and includes magnetic poles magnetized in an axial direction of the axis of rotation and arranged to alternate in polarity in the circumferential direction. A magnetic flux inducing ring includes an annular ring body attached to the other of the rotatable members and is arranged coaxially with the axis of rotation, and a plurality of protrusions having a circumferential width smaller than a circumferential width of a magnetic pole. A magnetic detection portion is configured to detect a magnetic flux of the ring body of the magnetic flux inducing ring. The flux inducing ring is magnetized depending on a relative positions the protrusions and positions of the magnetic poles.

### CROSS-REFERENCE TO RELATED APPLICATIONS

This application claims priority under 35 U.S.C. §119 to Japanese Patent Application No. 2012-202935 filed on Sep. 14, 2012, the entire disclosure of which is incorporated herein by reference in its entirety.

### BACKGROUND OF THE INVENTION

1. Field of the Invention

The present invention relates to, inter alia, a relative rotational angular displacement detection device used to detect a relative rotational angular displacement of a pair of rotatable members arranged coaxially with each other.

More specifically, the present invention relates to a relative rotational angular displacement detection device preferably for use in a power assist system for, e.g., a power assist wheelchair, a power assist bicycle, a power steering wheel, etc. The present invention also relates to a torque detection device using the relative rotational angular displacement detection device, and a torque control device using the relative rotational angular displacement detection device. It also relates to a power assist wheelchair, a power assist straddle-type vehicle, and a power steering device equipped with the torque control device.

2. Description of the Related Art

For example, in a conventional manual wheelchair, a pair of hand rims are arranged outside of a pair of right and left rear wheels and coaxially connected thereto. When a user rotates the hand rim, the rotational force is transmitted to the wheel to move the wheelchair. In recent years, for the purpose of reducing the burden of moving the hand rim by a user, a power assist system has been developed, in which an appropriate assisting force corresponding to the manual force for moving the hand rim is transmitted to a driving wheel by an electric motor.

According to this system, the manual force for moving the hand rim of the wheelchair and the rotational force of the electric motor output in accordance with the manual force are integrated to rotate the wheels, which enables easy moving of the wheelchair. This kind of power assist system can be applied not only to a wheelchair but also to a power assist bicycle, a power steering device of an automobile, etc.

This kind of power assist system is provided with a detection device for detecting a torque by detecting a relative rotational angular displacement of a pair of rotatable members coaxially arranged with each other in a relatively rotatable manner. As a device for detecting such a relative rotational angular displacement or a relative rotational torque, Japanese Unexamined Laid-open Patent Application Publication No. 2008-249366 discloses the following device. The device includes a pair of first and second shafts arranged coaxially with each other, a cylindrical magnet fixed to the first shaft, a pair of yoke rings fixed to the second shaft, a pair of magnetic flux inducing rings each arranged so as to surround each yoke ring and each having a magnetic flux inducing projection, and a magnetic sensor arranged between the magnetic flux inducing projections and configured to detect magnetic flux changes occurred in the yoke rings according to the relative angular displacements of the first and second shafts.

In the relative rotational angular displacement detection device, the first shaft is coaxially provided with the cylindrical magnet so as to rotate together with the first shaft. The cylindrical magnet includes magnetic poles, i.e., N-poles and S-poles, magnetized in a radial direction of an axis of rotation and arranged alternately in a circumferential direction of the axis of rotation. The second shaft is provided with the pair of yoke rings which rotate together with the second shaft. Each yoke ring includes triangular shaped ledges corresponding to the N-poles and S-poles.

Each ledge is arranged outside of the cylindrical magnet so as to face the pole of the cylindrical magnet in the radial direction of the axis of rotation. The pair of yoke rings are arranged such that the ledges of one of the yoke rings and the ledges of the other of the yoke rings are arranged so as to oppose in an axial direction of the axis of rotation and arranged alternately in the circumferential direction. A pair of magnetic flux inducing rings each for inducing the magnetic flux generated in each yoke ring is arranged radially outside of the corresponding yoke rings.

When the first shaft and the second shaft are relatively rotated, the relative position of each yoke ring with respect to the magnetic pole of the cylindrical magnet is changed. This causes magnetic flux changes between the magnetic flux inducing rings. The magnetic flux changes are detected by a magnetic sensor.

### SUMMARY OF THE INVENTION

In the aforementioned detection device, in order to detect the magnetic flux changes with a higher degree of accuracy, it is necessary to arrange the pair of yoke rings so that the triangular shaped ledges formed on the pair of yoke rings are closely arranged alternately in the circumferential direction with the circumferential distance of the adjacent ledges kept constant and with the axial distance of the opposing ledges kept constant. Furthermore, it was necessary to arrange the ledges so that the gap between each ledge and the cylindrical magnet is kept constant in the radial direction. This requires a high dimensional accuracy of each yoke ring in the circumferential direction, in the axial direction and in the radial direction, and also requires a high assembly accuracy of the yoke rings and the cylindrical magnet. Thus, to increase the detection accuracy, the production cost and the assembly cost of the detection device is increased.

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a relative rotational angular displacement detection device simple in structure and simple in assembly work and capable of detecting a relative rotational angular displacement of a pair of rotatable members arranged coaxially with each other with a high degree of accuracy.

Among other potential advantages, some embodiments can provide a torque detection device using the relative rotational angular displacement detection device, and a torque control device using the relative rotational angular displacement detection device.

Among other potential advantages, some embodiments can provide a power assist wheelchair, a power assist straddle-type vehicle, and a power steering device equipped with the torque control device.

Other objects and advantages of the present invention will be apparent from the following preferred embodiments.

According to some embodiments of the present invention, a relative rotational angular displacement detection device is equipped with a pair of rotatable members, a permanent magnet, a magnetic flux inducing ring, and a magnetic detection portion.

The relative rotational angular displacement detection device includes a pair of rotatable members relatively rotatable in a circumferential direction of an axis of rotation, and a permanent magnet attached to one of the pair of rotatable members and including magnetic poles magnetized in an axial direction of the axis of rotation and arranged so as to alternately change in polarity in the circumferential direction of the axis of rotation.

The device further includes a magnetic flux inducing ring including an annular ring body attached to the other of the pair of rotatable members and arranged coaxially with the axis of rotation and a plurality of protrusions each having a circumferential width smaller than a circumferential width of each magnetic pole.

The device further includes a magnetic detection portion for detecting a magnetic flux of the ring body of the magnetic flux inducing ring magnetized depending on a relative position of each protrusion of the magnetic flux inducing ring and each magnetic pole of the permanent magnet.

In some exemplary embodiments of the relative rotational angular displacement detection device, the ring body of the magnetic flux inducing ring includes an annular plane portion extending in a direction intersecting with a magnetization direction of the permanent magnet, and the magnetic detection portion is configured to detect a magnetic flux of the annular plane portion of the ring body. By constituting such that the permanent magnet is magnetized in the axial direction of the axis of rotation, the protrusions of the magnetic flux inducing ring are arranged so as to face the permanent magnet with a gap in the axial direction of the axis of rotation, and the ring body includes the annular plane portion extending in a direction intersecting with the magnetization direction of the permanent magnet, the magnetic flux inducing ring can be produced with a high degree of accuracy. Further, by constituting such that the magnetic detection portion detects the magnetic flux of the annular plane portion of the ring body of the magnetic flux inducing ring, the detection accuracy can be enhanced.

In some exemplary embodiments of the relative rotational angular displacement detection device, the magnetic detection portion includes a magnetic sensor for detecting a magnetic flux, and the magnetic sensor is a sensor for detecting a magnetic flux in the magnetization direction of the permanent magnet among magnetic fluxes of the annular plane portion. By constituting such that the permanent magnet is magnetized in the axial direction of the axis of rotation, the protrusions of the magnetic flux inducing ring are arranged so as to face the permanent magnet with a gap in the axial direction of the axis of rotation, the ring body includes the annular plane portion extending in a direction intersecting with the magnetization direction of the permanent magnet, and the magnetic sensor is a sensor for detecting a magnetic flux in the magnetization direction of the permanent magnet among magnetic fluxes of the annular plane portion, the relative rotational angular displacement detection device can be produced with a high degree of accuracy. Further, the detection accuracy can be improved.

In some exemplary embodiments of the relative rotational angular displacement detection device, at least one of the ring body of the magnetic flux inducing ring and the magnetic sensor is arranged at a position different in an axial direction of the axis of rotation with respect to the protrusion of the magnetic flux inducing ring. By employing the structure for defining the relative position in the axial direction of the axis of rotation or the structure in which at least one of the ring body of the magnetic flux inducing ring and the magnetic sensor is arranged at a position different in an axial direction of the axis of rotation with respect to the protrusion of the magnetic flux inducing ring, the relative rotational angular displacement detection device can be produced with a high degree of accuracy, which in turn can improve the detection accuracy.

In some exemplary embodiments of the relative rotational angular displacement detection device, the magnetic detection portion includes an intermediate yoke having a first plane portion, and the first plane portion is arranged between the magnetic sensor and the ring body and arranged so as to face the annular plane portion of the ring body with a gap in the magnetization direction of the permanent magnet.

In some exemplary embodiments of the relative rotational angular displacement detection device, an area of the first plane portion of the intermediate yoke is smaller than an area of the annular plane portion of the ring body.

In some exemplary embodiments of the relative rotational angular displacement detection device, at least one of the ring body, the intermediate yoke and the magnetic sensor is arranged at a position different in a radial direction of the axis of rotation with respect to the protrusion of the magnetic flux inducing ring.

According to other embodiments of the present invention, a torque detection device equipped with one of the aforementioned relative rotational angular displacement detection devices includes an elastic member arranged between the pair of rotatable members. An urging force is always applied to the pair of rotatable members by the elastic member in a relative rotation direction. The pair of rotatable members includes a relative rotation restriction portion configured to prevent a relative rotation of the pair of rotatable members when one of the pair of rotatable members is relatively rotated against the urging force of the elastic member by a certain angle with respect to the other of the pair of rotatable members.

According to still other embodiments of the present invention, a torque control device equipped with one of the aforementioned relative rotational angular displacement detection devices includes a rotation driving member attached to one of the pair of rotatable members, a rotation force beings given to the rotation driving member by a use, a power source configured to give a rotation force to the other of the pair of rotatable members, and a control portion configured to control a rotation force given to the other of the pair of rotatable members by the power source depending on an output of the magnetic detection portion when the one of the pair of rotatable members is relatively rotated by a certain rotational angle with respect to the other of the pair of rotatable members. Here, it should be understood that the wordings of “one of the pair of rotatable members” and “the other of the pair of rotatable member” mentioned here can be the same as or different from the previously mentioned wordings of “one of the pair of rotatable members” and “the other of the pair of rotatable member.”

According to still other embodiments of the present invention, a power assist wheelchair equipped with the torque control device can be provided.

According to still other embodiments of the present invention, a power assist straddle-type vehicle equipped with the torque control device can be provided.

According to some exemplary embodiments of the present invention, a power steering device equipped with the torque control device can be provided.

According to some exemplary embodiments of the present invention, the permanent magnet is attached to one of the pair of rotatable members relatively rotatable in the circumferential direction of the axis of rotation so that the magnetic poles magnetized in the axial direction of the axis of rotation are arranged so as to alternately change in polarity in the circumferential direction of the axis of rotation, the plurality of protrusions of the magnetic flux inducing ring are arranged so as to face the permanent magnet with a gap in the axial direction of the axis of rotation, and the protrusion has a circumferential width smaller than a circumferential width of each magnetic pole. Therefore, the protrusion of the magnetic flux inducing ring can be formed into a simple shape, which in turn can produce the magnetic flux inducing ring with a high degree of accuracy. Further, since the plurality of protrusions of the magnetic flux inducing ring are arranged so as to face the permanent magnet via a gap in the axial direction of the axis of rotation, the relative position with respect to the permanent magnet can be determined only by the gap in the axial direction. This enables high-precision assembly. Therefore, a relative rotational angular displacement of the pair of rotatable members which are relatively rotatable can be detected with a high degree of accuracy.

### BRIEF EXPLANATION OF THE DRAWINGS

The preferred embodiments of the present invention are shown by way of example, and not limitation, in the accompanying figures, in which:

FIG. 1 is an explanatory view showing a schematic structure of a relative rotational angular displacement detection device according to an embodiment of the present invention;

FIG. 2 is an enlarged cross-sectional view showing a portion “A” surrounded by a dash line in FIG. 1;

FIG. 3A is a schematic structural view of a principle portion of the aforementioned device as seen in an axial direction of an axis of rotation in a state in which the relative rotational angular displacement is zero degree;

FIG. 3B is a schematic structural view of a principle portion of the aforementioned device as seen in the axial direction of the axis of rotation in a state in which the relative rotational angular displacement is ten degrees;

FIG. 4A is an explanatory view showing a relative positional relation of magnetic poles of a permanent magnet and protrusions of a magnetic flux inducing ring in the state shown in FIG. 3A;

FIG. 4B is an explanatory view showing a relative positional relation of the magnetic poles of the permanent magnet and the protrusions of the magnetic flux inducing ring in the state shown in FIG. 3B;

FIG. 5A is an explanatory view showing a magnetic flux distribution of the magnetic poles of the permanent magnet and the magnetic flux inducing ring in the state shown in FIG. 3A;

FIG. 5B is an explanatory view showing a magnetic flux distribution of the permanent magnet, the magnetic flux inducing ring, an intermediate yoke, a magnetic sensor, and a back yoke in the state shown in FIG. 3A;

FIG. 5C is an explanatory view showing a magnetic flux distribution of the permanent magnet, the magnetic flux inducing ring, the intermediate yoke, the magnetic sensor, the back yoke and the vicinity thereof in the state shown in FIG. 3A;

FIG. 6A is an explanatory view showing a relative positional relation of the magnetic poles of the permanent magnet and the magnetic flux inducing ring in the state shown in FIG. 3B;

FIG. 6B is an explanatory view showing a magnetic flux distribution of the permanent magnet, the magnetic flux inducing ring, the intermediate yoke, the magnetic sensor, and the back yoke in the state shown in FIG. 3B;

FIG. 6C is an explanatory view showing a magnetic flux distribution of the permanent magnet, the magnetic flux inducing ring, the intermediate yoke, the magnetic sensor, the back yoke and the vicinity thereof in the state shown in FIG. 3B; .

FIG. 7 is a schematic explanatory view showing a relative rotational angular displacement device according to the present invention applied to a power assist system for a power assist bicycle;

FIG. 8 is a schematic explanatory view showing a relative rotational angular displacement device according to the present invention applied to a power assist system for a power assist wheelchair; and

FIG. 9 is a schematic explanatory view showing a relative rotational angular displacement device according to the present invention applied to a power assist system for a power steering device.

### DETAILED DESCRIPTION OF THE PREFERRED EMBODIMENTS

In the following paragraphs, some preferred embodiments of the present invention will be described with reference to the attached drawings by way of example and not limitation. It should be understood based on this disclosure that various other modifications can be made by those in the art based on these illustrated embodiments.

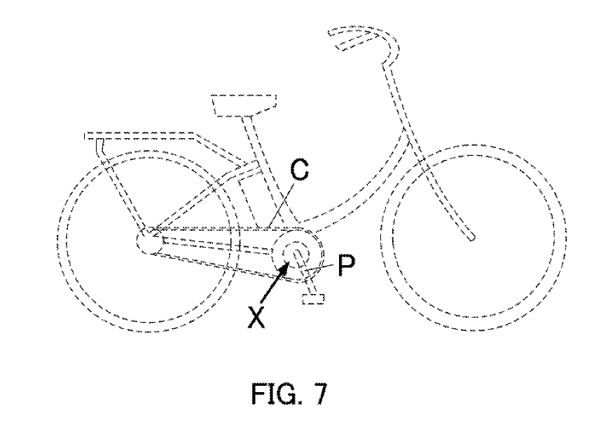

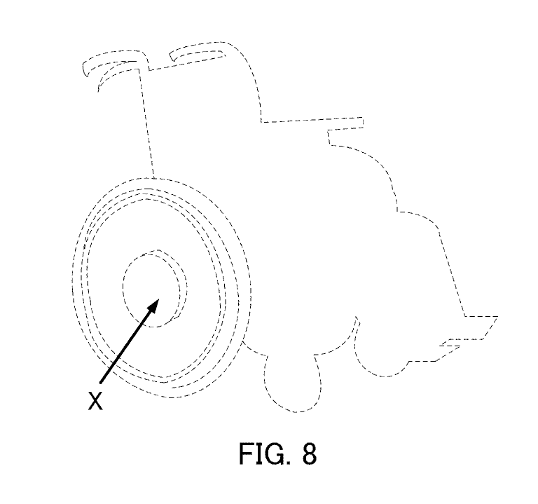

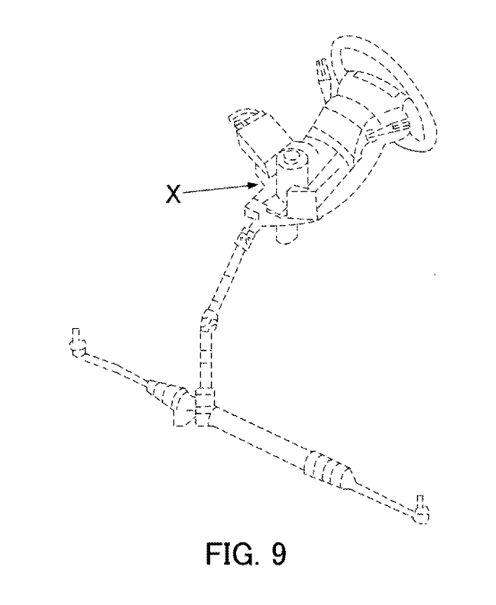

Hereinafter, an embodiment of the present invention in which a relative rotational angular displacement detection device according to the present invention is applied to a power assist system X for a power assist bicycle (see FIG. 7) will be explained with reference to the attached drawings. Needless to say, the relative rotational angular displacement detection device according to the present invention is not limited to the case in which the device is used in a power assist system for a power assist bicycle, and can also be applied to various devices and mechanisms for detecting a relative rotational angular displacement of a pair of rotatable members which are movable relatively. For example, the present invention can also be preferably applied to, e.g., a power assist system X for a power assist wheelchair (see FIG. 8), a power steering device for an automobile (see FIG. 9), etc.

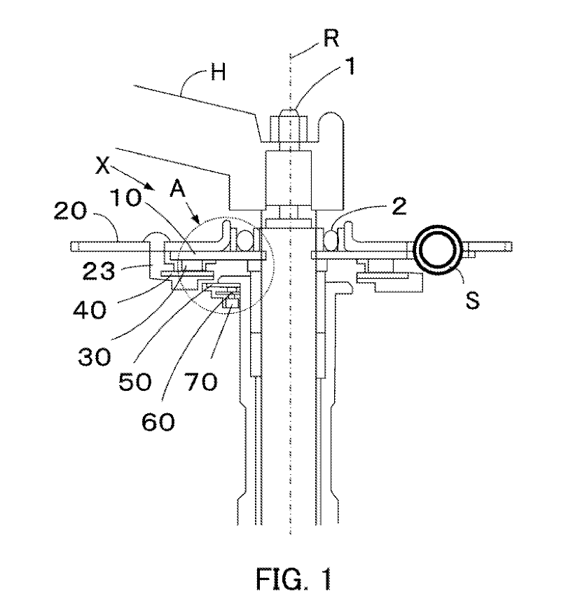

As shown in FIGS. 1 and 7 for example, in the relative rotational angular displacement device X according to the embodiment, a pedal P is attached to one end of a shaft 1. A lever member 10 as a first rotatable member and a sprocket 20 as a second rotatable member are arranged coaxially with the shaft 1, i.e., arranged coaxially with the axis R of rotation. As shown in this figure, the lever member 10 and the sprocket 20 are arranged closely with each other in an adjacent manner so as to be relatively rotatable in the circumferential direction of the axis R of rotation. The circumferential direction of the axis R of rotation may also mean a rotational direction that the lever member 10 and sprocket 20 rotate around the axis R. The circumferential direction of the axis R of rotation may also be the same as a rotational direction of the lever member 10 and the sprocket 20.

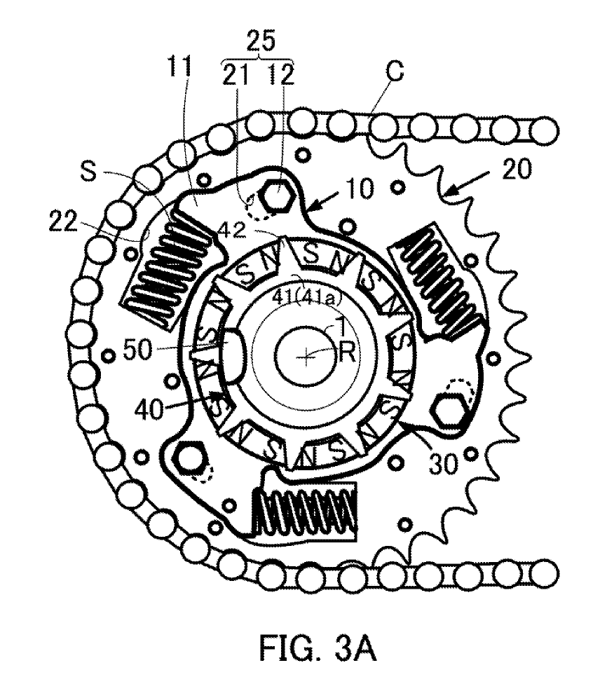

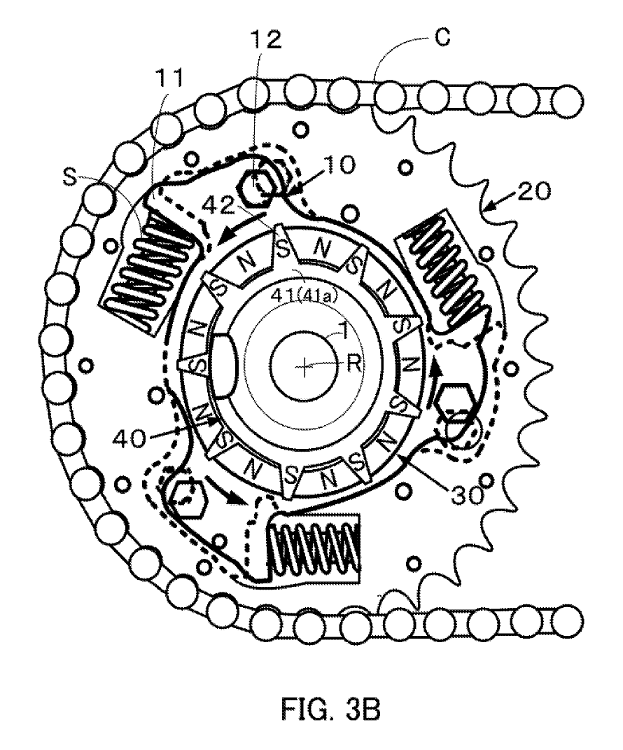

As shown in FIG. 3A, the lever member 10 as a first rotatable member is integrally provided with three engaging portions 11 extending radially outward of the shaft 1, and is configured to rotate together with the shaft 1 in accordance with the rotation of the pedal P. On the other hand, as shown in FIG. 1, the sprocket 20 as a second rotatable member is arranged coaxially with the shaft 1 via a bearing 2 in a relatively rotatable manner with respect to the lever member 10 as a first rotatable member.

As shown in FIG. 3A, each engaging portion 11 of the lever member 10 is provided with an engaging protrusion 12 protruded in an axially outward direction, i.e., protruded toward the sprocket 20. Each protrusion 12 is fitted in an arc-shaped slit 21 formed in the sprocket 20. The slit 21 extends in the circumferential direction. This engaging protrusion 12 is slidably movable within a length range extending in the circumferential direction of the slit 21 in accordance with the rotational movement of the lever member 10. The engaging protrusion 12 and the slit 21 constitute a relative rotation restriction portion 25 which restricts the relative rotation of the lever member 10 as a first rotatable member and the sprocket 20 as a second rotatable member.

In the sprocket 20, spring mounting holes 22 each for mounting a coil spring S are formed at three circumferential positions. In each spring mounting hole 22, a coil spring S is mounted. One end portion of this coil spring S is engaged with one circumferential end portion of the spring mounting hole 22, and the other end portion thereof is engaged with the engaging portion 11 of the lever member 10, so that the engaging portion 11 of the lever member 10 is urged by the spring Sin the circumferential direction (in the clockwise direction in FIG. 3A). In a state in which no rotational force is applied to the pedal P by a user, the engaging protrusion 12 provided at each engaging portion 11 of the lever member 10 is engaged with one circumferential end of each slit 21.

Accordingly, from the state shown in FIG. 3A, when a rotational force is applied to the pedal S in a counterclockwise direction, the shaft 1 connected to the pedal P rotates as shown in FIG. 3B. In accordance with the rotation of the pedal P, the rotational force is given to the lever member 10 fixed to the shaft 1, resulting in a rotation of the lever member 10 in the counterclockwise direction. When the lever member 10 rotates in the counterclockwise direction, the engaging portion 11 rotates relative to the sprocket 20 while pushing against the urging force of the spring S mounted on the sprocket 20. At this time, the engaging protrusion 12 provided at the engaging portion 11 of the lever member 10 moves in the circumferential direction (in the counterclockwise direction) in the slit 21 formed in the sprocket 20.

When the engaging protrusion 12 provided at the engaging portion 11 of the lever member 10 reaches the other circumferential end of the slit 21, the engaging protrusion 12 is engaged with the other circumferential end of the slit 21. Therefore, the sprocket 20 thereafter rotates in the counterclockwise direction together with the lever member 10 in accordance with the rotation of the lever member 10. Even until the engaging protrusion 12 reaches the other circumferential end of the slit 21, the sprocket 20 rotates in the counterclockwise direction by the urging force of the spring S.

As explained above, in this embodiment, the lever member 10 as a first rotatable member and the sprocket 20 as a second rotatable member are relatively movable within a certain range in the circumferential direction of the shaft 1, i.e., within a length range in the circumferential direction of the slit 21 formed in the sprocket 20. By detecting the relative rotational angular displacement of the rotatable members 10 and 20 within the limited relative rotational range in the circumferential direction, in other words, the relative rotational torque, an electric motor (not illustrated) is controlled, so that a rotational force given to the pedal P and a rotational force of the electric motor output in accordance with the rotational force are combined to thereby control a rotational force of a rear wheel via a chain C engaged with the sprocket 20 (see FIG. 7).

In order to detect the relative rotational angular displacement of the lever member 10 as a first rotatable member and the sprocket 20 as a second rotatable member, in this embodiment, as shown in FIGS. 1 to 3, the device includes, as main structural members, a permanent magnet 30, a magnetic flux inducing ring 40, and a magnetic detection portion 100.

The permanent magnet 30 is an annular or ring-shaped magnet, such as, e.g., an annular or ring-shaped bond magnet, arranged coaxially with the axis R of rotation, or coaxially arranged with the shaft 1 as shown in FIG. 3A, in which the magnetic poles, i.e., N-poles and S-poles, are arranged alternately in the circumferential direction of the shaft 1. Each magnetic pole is magnetized in the axial direction of the shaft 1, i.e., in a direction parallel to the axial direction of the axis R of rotation. It should be noted, however, that it is not always required that the magnetization direction is in completely parallel with the axial direction of the axis R of rotation but can be inclined within a range of 45 degrees with respect to the axial direction.

In this embodiment, nine pairs of magnetic poles (a total of 18 magnetic poles, nine S-poles and nine N-poles) are arranged at equal intervals in the circumferential direction. This annular or ring-shaped permanent magnet 30 is arranged coaxially with the lever member 10 and fixed to the lever member 10, so that the permanent magnet 30 rotates in accordance with the rotation of the lever member 10. It should be noted, however, that in the present invention the permanent magnet 30 is not limited to the aforementioned annular or ring-shaped permanent magnet, but can be constituted by a plurality of separate permanent magnets arranged at equal intervals in the circumferential direction. Further, the permanent magnet 30 can be either a sintered magnet or a bond magnet, and also can be either an isotropic magnet or an anisotropic magnet. Further, the permanent magnet 30 can be a polar anisotropic magnet.

The magnetic flux inducing ring 40 is, as shown in FIGS. 1 to 3, arranged coaxially with the sprocket 20. The magnetic flux inducing ring 40 includes an annular ring body 41 and a plurality of protrusions 42 protruded in a radially outward direction from the outer peripheral edge of the ring body 41. The ring body 41 is arranged so as not to overlap the permanent magnet 30 in the radial direction of the shaft 1. In other words, the ring body 41 is arranged so as not to overlap the permanent magnet 30 when seen in the axial direction of the shaft 1. The plurality of protrusions 42 are arranged so as to overlap the permanent magnet 30 in the radial direction. In other words, the plurality of protrusions 42 overlaps the permanent magnet 30 when seen in the axial direction of the shaft 1.

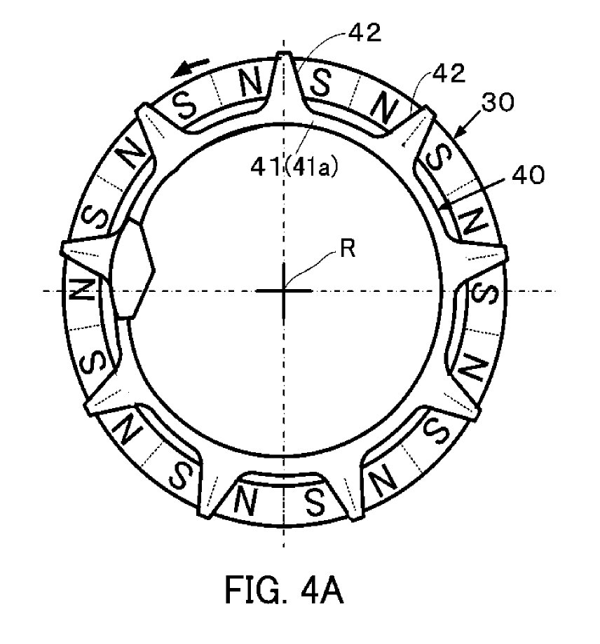

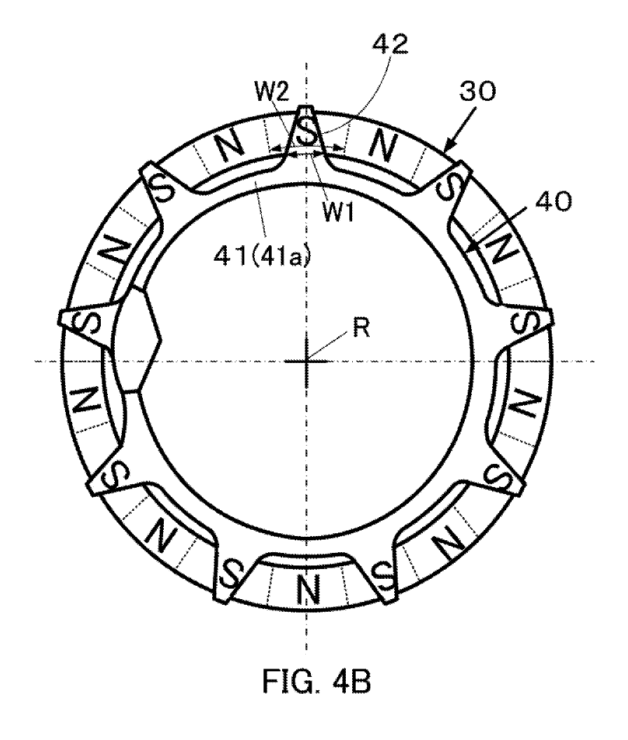

The number of protrusions 42 is equal to the number of pairs of magnetic poles of the permanent magnet 30. Each protrusion 42 has a circumferential width W1 smaller than a circumferential width W2 of each magnetic pole. More specifically, the ring body 41 of the magnetic flux inducing ring 40 is provided with an annular plane portion 41a extending in a direction intersecting with the magnetization direction of the permanent magnet 30, i.e., extending in a radial direction of the shaft 1. On the other hand, each protrusion 42 of the magnetic flux inducing ring 40 is formed into a tapered triangular shape or a trapezoidal shape with the width decreasing toward the radially outward direction (see FIGS. 4A and 4B). As shown in FIG. 1, this magnetic flux inducing ring 40 is integrally secured to the sprocket 20 via an attachment 23 in a state in which the ring 40 is detached from the sprocket 20 in the axial direction. That is, the magnetic flux inducing ring 40 is configured to integrally rotate with the sprocket 20.

In this embodiment, it is exemplified that each protrusion 42 of the magnetic flux inducing ring 40 extends in a radially outward direction. However, the protrusion 42 of the magnetic flux inducing ring 40 is not limited to it. For example, the protrusion 42 of the magnetic flux inducing ring 40 can be a protrusion extending in a radially inward direction. That is, it can be configured such that the ring body 41 is arranged radially outward of the annular permanent magnet 30 and the protrusions 42 extend from the ring body 41 in a radially inward direction.

The magnetic flux inducing ring 40 can be preferably produced by punching a steel plate, etc., but the magnetic flux inducing ring 40 can be constituted by connecting a plurality of members. Further, in this embodiment, it is exemplified that the magnetic flux inducing ring 40 includes the ring body 41 and protrusions 42 that are formed on the same plane, but not limited to it. For example, the protrusion 42 can be formed into a shape bent at a certain angle with respect to the ring body 41.

Each protrusion 42 of the magnetic flux inducing ring 40 is positioned in between the S-pole and the N-pole of the permanent magnet 30 in an initial state in which no external force is applied to the shaft 1 as shown in FIG. 3A. When an external force is applied to the shaft 1 from the initial state, the lever member 10 rotates. In accordance with the rotation, the lever member 10 is relatively displaced or rotated with respect to the sprocket 20. At this time, the engaging protrusion 12 provided at the engaging portion 11 of the lever member 10 moves along the slit 21 formed in the sprocket 20. The engaging protrusion 12 of the lever member 10 moves along the slit 21 until the engaging protrusion 12 is engaged with the other circumferential end of the slit 21 and the relative movement of the engaging protrusion 12 with respect to the sprocket 20 is limited.

In a state in which the engaging protrusion 12 of the lever member 10 is moved and engaged with the other circumferential end of the slit 21, as shown in FIG. 3B, all of the protrusions 42 of the magnetic flux inducing ring 40 are positioned so that the overlapping area of the protrusion 42 and the S-pole of the permanent magnet 30 becomes large.

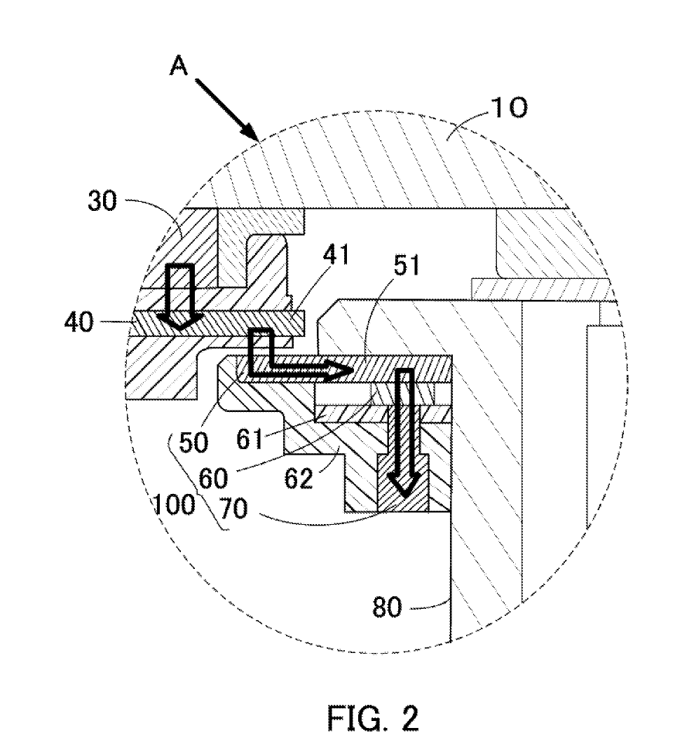

The magnetic detection portion 100 is configured to detect the magnetic flux of the ring body 41 of the magnetic flux inducing ring 40 magnetized depending on the relative position of the protrusion 42 of the magnetic flux inducing ring 40 and the magnetic pole of the permanent magnet 30. As shown in FIG. 2, the magnetic detection portion 100 includes an intermediate yoke 50, a magnetic sensor 60, and a back yoke 70.

The intermediate yoke 50 includes a first plane portion 51 as shown in FIG. 2. This first plane portion 51 is arranged close to the magnetic flux inducing ring 40 via a certain gap in a state in which the radially outward portion of the first plane portion 51 overlaps the ring body 41 of the magnetic flux inducing ring 40 in the radial direction of the ring body 41, i.e., the radially outward portion of the first plane portion 51 overlaps the ring body 41 when seen in the axial direction of the shaft 1.

This intermediate yoke 50 is made of a ferromagnetic substance, such as, e.g., iron, and configured to induce the magnetic flux of the magnetic flux inducing ring 40 magnetized by the permanent magnet 30 and also to decrease the amplitude of the magnetic flux. The area of the first plane portion 51 of the intermediate yoke 50 is smaller than the area of the annular plane portion 41a of the ring body 41.

The magnetic sensor 60 is an element for detecting the magnetic flux passing through the intermediate yoke 50 and is arranged to overlap the intermediate yoke 50 in the radial direction, i.e., arranged to overlap the intermediate yoke 50 when seen in the axial direction of the shaft 1 as shown in FIGS. 1 and 2. As the magnetic sensor 60, for example, a Hall element (Hall IC) can be preferably used. As shown in FIG. 2, the magnetic sensor 60 is attached to a resin base plate 61 and fixed to a vehicle side non-rotatable member 80 via a base plate holder 62.

The back yoke 70 is made of a ferromagnetic substance, such as, e.g., iron, and is integrally embedded in the base plate holder 62. This back yoke 70 is arranged adjacent to the magnetic sensor 60 in a manner such that the back yoke 70 overlaps the magnetic sensor 60 in the radial direction, i.e., the back yoke 70 overlaps the magnetic sensor 60 when seen in the axial direction of the shaft 1.

In detail, the intermediate yoke 50, the magnetic sensor 60 and the back yoke 70 are integrated so as to overlap with each other when seen in the axial direction of the shaft 1, and constitute a magnetic flux inducing path as a part of a magnetic path of the magnetic flux of the magnetic flux inducing ring 40 magnetized by the permanent magnet 30. As explained above, although the magnetic flux inducing path is formed by the intermediate yoke 50, the magnetic sensor 60, and the back yoke 70, the magnetic path of the permanent magnet 30 is not constituted such that the entire magnetic path from one of the magnetic pole to the other thereof positively constitutes a magnetic closed loop circuit small in magnetic resistance. In other words, it is constituted as if the magnetic circuit terminates at the back yoke 70.

By employing such structure, it is possible to detect the changes of the magnetic flux passing between the intermediate yoke 50 and the back yoke 70 with no practical issues while simplifying the structure of the entire device. Needless to say, it is acceptable that a magnetic closed loop circuit is eventually formed by, for example, a vehicle side structural part, such as, e.g., the shaft 1.

Further, in this embodiment, as explained above, the intermediate yoke 50, the magnetic sensor 60 and the back yoke 70 are fixed to the vehicle side non-rotatable member 80, independently of the lever member 10 as a first rotatable member and the sprocket 20 as a second rotatable member. This further simplifies the mounting structure. Furthermore, the magnetic sensor side structure is non-rotatable, which causes less problems.

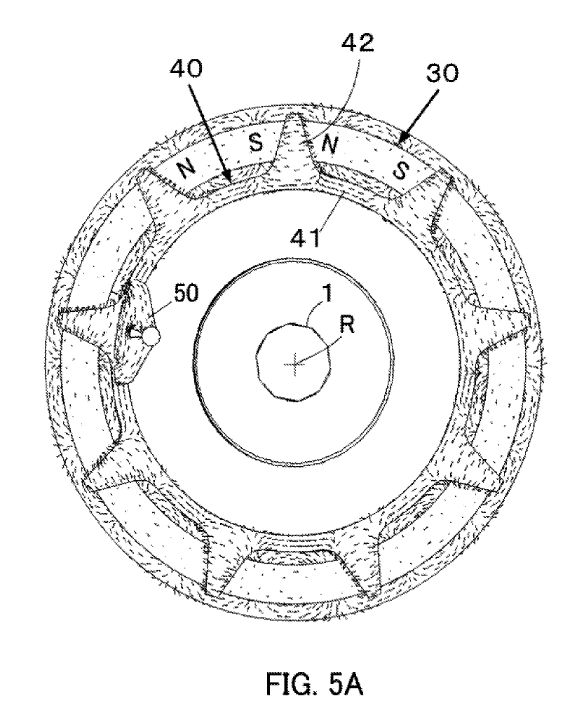

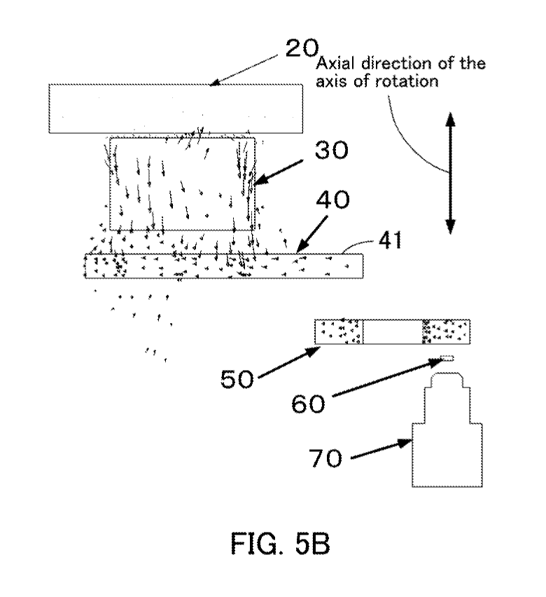

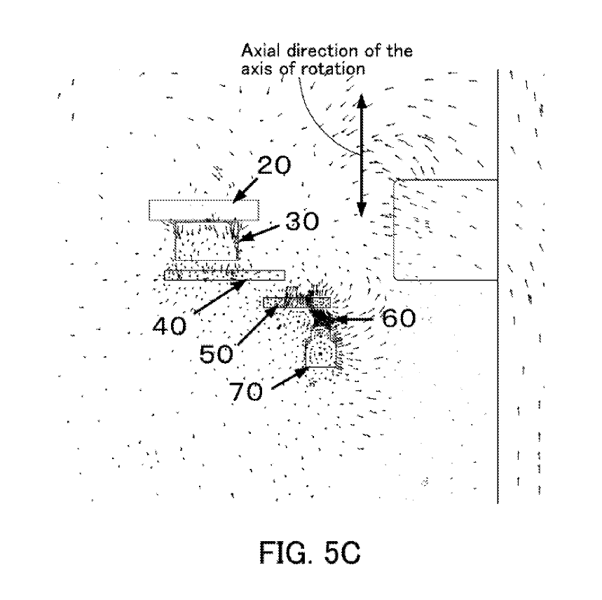

Next, the operating principle of the relative rotational angular displacement detection device of this embodiment will be explained. FIG. 4A shows an initial state (corresponding to the state shown in FIG. 3A) in which the lever member 10 as a first rotatable member and the sprocket 20 as a second rotatable member are not relatively rotated. In this initial state, each protrusion 42 of the magnetic flux inducing ring 40 is positioned at an intermediate position of the adjacent magnetic poles of the permanent magnet 30, i.e., positioned between the N-pole and the S-pole. In this initial state, each protrusion 42 constitutes a magnetic path of the adjacent N-pole and S-pole as shown in FIG. 5A.

As shown in FIG. 4A, in the initial state, when seen in the axial direction of the shaft 1, the ring body 41 is positioned such that each protrusion 42 is positioned between the N-pole and the S-pole and that the overlapping area of the S-pole and the protrusion 42 and the overlapping area of the N-pole and the protrusion 42 are equal. Therefore, the ring body 41 is weakly magnetized to N-poles and S-poles alternately in the circumferential direction corresponding the N-poles and the S-poles of the permanent magnet 30. In other words, the ring body 41 maintains a so-called magnetically neutral or almost neutral state (see FIG. 5A).

In the illustrative embodiment, as shown in the figures, the outer peripheral edge of the ring body 41 and the inner peripheral edge of the permanent magnet 30 are set to have a narrow gap therebetween. Therefore, as explained above, although the ring body 41 is weakly magnetized to N-poles and the S-poles alternately in the circumferential direction corresponding to the N-poles and the S-poles of the permanent magnet 30, by increasing the gap, the magnetization state of the ring body 41 becomes further weak, which results in further improved detection accuracy.

Accordingly, in this initial state, the magnetic flux from the magnetic flux inducing ring 40 (ring body 41) to the intermediate yoke 50 is very weak, or almost no magnetic flux exists between the magnetic flux inducing ring 40 and the intermediate yoke 50 (see FIGS. 5B and 5C). In this initial state, the magnetic flux of the ring body 41 of the magnetic flux inducing ring 40 weakly magnetized to N-poles and S-poles alternately in the circumferential direction is induced by the intermediate yoke 50 and the back yoke 70 which are arranged adjacent to the ring body 41 of the magnetic flux inducing ring 40 and intensively flows through the magnetic sensor 60 arranged between the intermediate yoke 50 and the back yoke 70 (see FIG. 5C). Accordingly, the magnetic sensor 60 can assuredly detect the magnetic flux of the ring body 41 of the magnetic flux inducing ring 40.

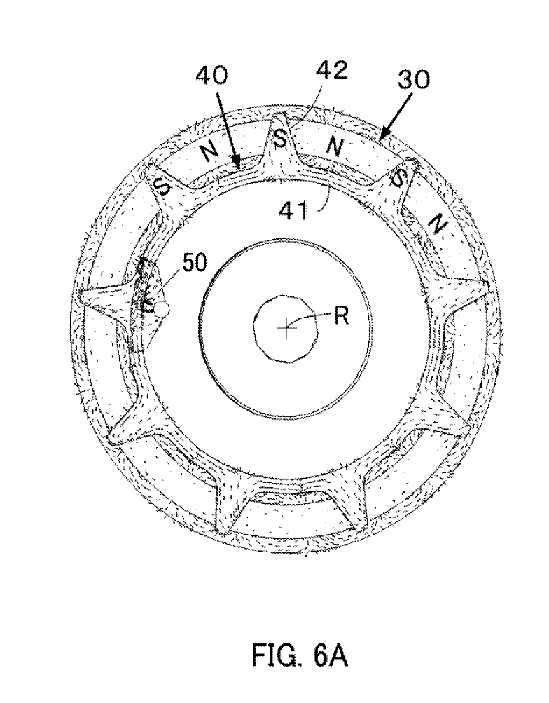

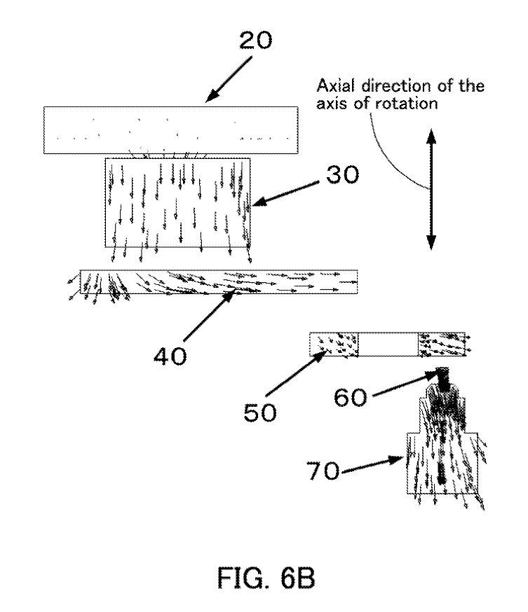

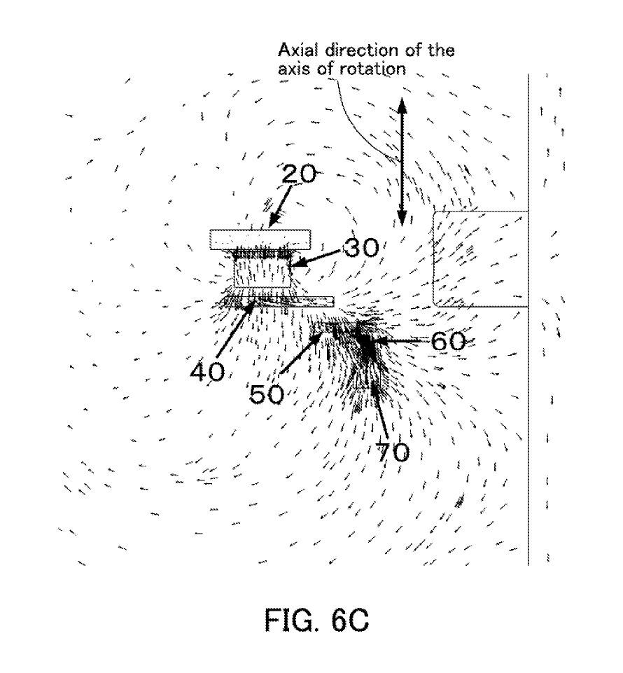

On the other hand, from the aforementioned initial state, when the lever member 10 rotates by a certain angle (10 degrees in this embodiment) in the counterclockwise direction so that each protrusion 42 of the magnetic flux inducing ring 40 overlaps one of magnetic poles (S-pole in this embodiment) of the permanent magnet 30 when seen in the axial direction, the protrusion 42 is strongly magnetized to the overlapping magnetic pole (S-pole in this embodiment) (see FIG. 6A). As a result, the ring body 41 of the magnetic flux inducing ring 40 is magnetized to the overlapping magnetic pole (S-pole in this embodiment) of the permanent magnet 30 along the entire circumference.

Accordingly, the magnet flux of the magnetic flux inducing ring 40 magnetized as mentioned above is induced by the intermediate yoke 50 and the back yoke 70 which are arranged adjacent to the magnetic flux inducing ring 40 and intensively flows through the magnetic sensor 60 arranged between the intermediate yoke 50 and the back yoke 70 (see FIG. 6C). As a result, the the magnetic sensor 60 can assuredly detect the magnetic flux of the ring body 41 of the magnetic flux inducing ring 40 magnetized to one of magnetic poles (S-pole in this embodiment) along the circumferential direction.

As will be understood from the above, by forming the magnetic flux inducing circuit only by the magnetic flux inducing ring 40, the intermediate yoke 50 and the back yoke 70, without positively forming a magnetic closed loop circuit, the displacement of the magnetic flux passing through the magnetic flux inducing circuit can be detected by the magnetic sensor 60 in a practically satisfactory manner. As shown in FIGS. 5C and 6C, also in this device, although the permanent magnet 30 forms a magnetic closed loop circuit via the magnetic flux inducing ring 40, the intermediate yoke 50 and the back yoke 70, it is not always required to positively form a magnetic closed loop circuit using members other than the aforementioned members.

The phrase “it is not always required to positively form a magnetic closed loop circuit” means that it is sufficient to positively form a magnetic flux inducing circuit by at least the magnetic flux inducing ring 40, the intermediate yoke 50 and the back yoke 70. In other words, in the present invention, it is not intended to exclude the case in which other vehicle constitutional members, such as, e.g., a shaft 1 or peripheral members thereof, eventually form a magnetic closed loop circuit together with the magnetic flux inducing ring 40, the intermediate yoke 50, and the back yoke 70. It should be understood that the present invention does not always require to positively form a magnetic closed loop circuit.

As explained above, the lever member 10 as a first rotatable member and the sprocket 20 as a second rotatable member are structured such that the relative rotational angle between the lever member 10 and the sprocket 20 is changed between the state shown in FIGS. 3A and 4A and the state shown in FIGS. 3B and 4B.

When the rotational force given to the pedal P is changed between the state shown in FIG. 3A in which no rotational force is given and the state shown in FIG. 3B in which a rotational force exceeding the urging force of the spring S is given, the relative rotational angle between the lever member 10 as a first rotatable member and the sprocket 20 as a second rotatable member changes. In accordance with the change, the magnetization state of the ring body 41 of the magnetic flux inducing ring 40 changes between the so-called magnetically neutral or almost neutral state in which the ring body 41 is weakly magnetized or almost not magnetized along the entire circumference and the state in which the entire ring body 41 is magnetized to a S-pole or a N-pole (S-pole in the embodiment).

As explained above, the magnetic sensor 60 detects the change of the magnetic flux depending on the relative rotational angular displacement of the permanent magnet 30 and the magnetic flux inducing ring 40 which corresponds to the rotational force given to the pedal P. Therefore, depending on the change of the detected magnetic flux, the relative rotational angular displacement is continuously detected. In this embodiment, since the spring S is mounted, the relative rotational angular displacement of the lever member 10 and the sprocket 20 can be detected, which in turn can detect the relative rotational torque displacement. Therefore, by controlling a power driving means (not illustrated) with a controller (not illustrated) based on the displacement, the rotational force of the pedal P can be assisted. Furthermore, the position and size of the magnetic sensor 60 is such that the magnetic sensor 60 may detect a magnetic flux of the annular plane portion 41a in the magnetization direction of the permanent magnet 30 among magnetic fluxes of the annular plane portion 41a.

In the aforementioned embodiment, the explanation was made by exemplifying the case in which the lever member 10 as a first rotatable member is displaced with respect to the sprocket 20 as a second rotatable member in a counterclockwise direction.

It should be noted, however, that it can be configured such that the lever member 10 as a first rotatable member is displaced with respect to the sprocket 20 as a second rotatable member in both directions, i.e., the counterclockwise direction and the clockwise direction. In this case, the direction of the magnet flux passing through the magnetic sensor 60 changes depending on the relative angular displacement direction of both the rotatable members 10 and 20, i.e., in the clockwise direction or in the counterclockwise direction. Therefore, when an electric motor (not illustrated) as an auxiliary power source is controlled using the output of the magnetic sensor 60 via a control circuit (not illustrated), in a power assist wheelchair for example, not only the forward driving but also the reverse driving can be assisted.

Further, in the aforementioned embodiment, the case in which a coil spring S is used as an elastic member is exemplified. It should be noted, however, that various springs can be utilized and it can be configured to detect the relative rotational angular displacement or the rotational torque of the first and second rotatable members 10 and 20 using other elastic member of various resin or metal, e.g., a torsional dumper, etc.

According to the embodiment of the present invention, the relative rotational angular displacement detection device includes the permanent magnet 30, the magnetic flux inducing ring 40, the intermediate yoke 50, the magnetic sensor 60, and the back yoke 70. The permanent magnet 30 is fixed to one of the pair of rotatable members 10 and 20 and includes S-poles and N-poles magnetized in the axial direction of the shaft 1 and arranged alternately in the circumferential direction of the shaft 1.

The magnetic flux inducing ring 40 includes the annular ring body 41 fixed to the other of the pair of rotatable members 10 and 20 and arranged so as not to overlap the permanent magnet 30 when seen in the axial direction of the shaft 1, and a plurality of protrusions 42 protruded from the ring body 41 in the radially outward direction of the shaft 1 and arranged so as to overlap the permanent magnet 30 when seen in the axial direction of the shaft 1. The number of protrusions 42 is equal to the number of pairs of magnetic poles. The circumferential width W1 of the protrusion 42 is smaller than the circumferential width W2 of each magnetic pole.

The intermediate yoke 50 is arranged adjacent to the ring body 41 of the magnetic flux inducing ring 40 to induce the magnetic flux of the magnetic flux inducing ring 40 magnetized depending on the relative position of each protrusion 42 of the magnetic flux inducing ring 40 and each magnetic pole of the permanent magnet 30. The intermediate yoke 50 constitutes a magnetic flux inducing circuit together with the back yoke 70.

The magnetic sensor 60 is arrange between the intermediate yoke 50 and the back yoke 70 and configured to detect the magnetic flux passing through the magnetic flux inducing path constituted by the intermediate yoke 50 and the back yoke 70.

Therefore, the relative rotational angular displacement detection device can assuredly detect the relative rotational angular displacement of the first rotatable member 10 and the second rotatable member 20 with a simple structure. Further, the relative rotational angular displacement detection device is configured to detect the magnetic flux passing through the magnetic flux inducing path constituted by the intermediate yoke 50 and the back yoke 70 with the magnetic sensor 60. This further simplifies the structure, the production and the assembly of the device, which in turn can reduce the cost.

It should be understood that the terms and expressions used herein are used for explanation and have no intention to be used to construe in a limited manner, do not eliminate any equivalents of features shown and mentioned herein, and allow various modifications falling within the claimed scope of the present invention.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.”

The present invention can be preferably applied to a relative rotational angular displacement detection device for use in a power assist system for, e.g., a power assist wheelchair, a power assist bicycle, a power steering wheel, etc., to detect a relative rotational angular displacement of a pair of rotatable members relatively rotatable in the circumferential direction of a rotation shaft. The present invention can also be preferably applied to a torque detection device or a torque control device using the detection device.

1. A relative rotational angular displacement detection device, comprising:
a pair of rotatable members rotatable relative to each other around an axis of rotation in a circumferential direction;
a permanent magnet attached to a first of the pair of rotatable members and including magnetic poles magnetized in an axial direction of the axis of rotation, the magnetic poles arranged so as to alternate in polarity in the circumferential direction, the magnetic poles each having a circumferential width;
a magnetic flux inducing ring including
a plurality of protrusions each having a circumferential width, at least one of the circumferential widths of the protrusions is smaller than at least one of the circumferential widths of the magnetic poles, and
an annular ring body attached to a second of the pair of rotatable members and arranged coaxially with the axis of rotation, the ring body being magnetized and having a strength of magnetization that changes depending on positions of the protrusions relative to positions of the magnetic poles; and
a magnetic detection portion configured to detect a magnetic flux of the ring body.

2. The relative rotational angular displacement detection device as recited in claim 1,
wherein the ring body includes an annular plane portion extending in a direction intersecting with a magnetization direction of the permanent magnet, and
wherein the magnetic detection portion is configured to detect the magnetic flux of the ring body by detecting a magnetic flux of the annular plane portion.

3. The relative rotational angular displacement detection device as recited in claim 2,
wherein the magnetic detection portion includes a magnetic sensor for detecting the magnetic flux of the ring body, and
wherein the magnetic sensor detects the magnetic flux of the ring body by detecting a magnetic flux, in the magnetization direction of the permanent magnet, among magnetic fluxes of the annular plane portion.

4. The relative rotational angular displacement detection device as recited in claim 3, wherein in an axial direction of the axis of rotation, at least one of the ring body and the magnetic sensor is arranged at a position different than that of the protrusions of the magnetic flux inducing ring.

5. The relative rotational angular displacement detection device as recited in claim 4,
wherein the magnetic detection portion includes an intermediate yoke having a first plane portion, and
further wherein in the magnetization direction of the permanent magnet, the first plane portion is arranged between the magnetic sensor and the ring body and arranged so as to face the annular plane portion of the ring body with a gap therebetween.

6. The relative rotational angular displacement detection device as recited in claim 5, wherein an area of the first plane portion of the intermediate yoke is smaller than an area of the annular plane portion of the ring body.

7. The relative rotational angular displacement detection device as recited in claim 6, wherein in a radial direction, at least one of the ring body, the intermediate yoke and the magnetic sensor is arranged at a position that is different than that of the protrusions.

8. The relative rotational angular displacement detection device as recited in claim 5,
wherein in a radial direction, at least one of the ring body, the intermediate yoke and the magnetic sensor is arranged at a position different than that of the protrusions of the magnetic flux inducing ring.

9. A torque detection device equipped with the relative rotational angular displacement detection device as recited in claim 1, comprising:
an elastic member arranged between the pair of rotatable members,
wherein an urging force is always applied to the pair of rotatable members by the elastic member in a relative rotational direction, and
further wherein the pair of rotatable members includes a relative rotation restriction portion, the relative rotation restriction portion is configured to prevent rotation of the pair of rotatable members relative to each other after one of the pair of rotatable members is relatively rotated, against the urging force of the elastic member, by a certain angle with respect to the other of the pair of rotatable members.

10. A torque control device equipped with the relative rotational angular displacement detection device as recited in claim 1, comprising:
a rotation driving member connected to the one rotatable member, wherein a rotation force is given to the rotation driving member by a user;
a power source configured to give a rotation force to the other of the pair of rotatable members; and
a control portion configured to control the rotation force given to the other of the pair of rotatable members by the power source depending on an output of the magnetic detection portion when the one of the pair of rotatable members is relatively rotated by a certain rotational angle with respect to the other of the pair of rotatable members.

11. A power assist wheelchair equipped with the torque control device as recited in claim 10.

12. A power assist straddle-type vehicle equipped with the torque control device as recited in claim 10.

13. A power steering device equipped with the torque control device as recited in claim 10.

14. The relative rotational angular displacement detection device as recited in claim 1, wherein the magnetic poles include a group of N-poles and a group of S-poles,
wherein the magnetic flux inducing ring has a first state in which the strength of magnetization is greater than that of a second state of the magnetic flux inducing ring,
wherein in the first state the protrusions are positioned relative to the magnetic poles such that the magnetic flux inducing ring is magnetized substantially equally by the group of N-poles and the group of S-poles, and in the second state the protrusions are positioned relative to the magnetic poles such that the magnetic flux inducing ring is magnetized by substantially only one of the group of N-poles and the group the S-poles.

15. The relative rotational angular displacement detection device as recited in claim 1, wherein each circumferential width of the protrusions is smaller than each circumferential width of the magnetic poles.
